(19) United States
(12) Patent Application Publication
(10) Pub. No.: US 2012/0045992 A1
(43) Pub. Date: Feb. 23, 2012

(54) APPARATUS AND METHOD FOR SHARING DATA IN PORTABLE TERMINAL

(75) Inventor: Oh-Hyuck KWON, Gyeonggi-do (KR)

(73) Assignee: SAMSUNG ELECTRONICS CO., LTD., Gyeonggi-Do (KR)

(21) Appl. No.: 13/213,197

(22) Filed: Aug. 19, 2011

(30) Foreign Application Priority Data
Aug. 20, 2010 (KR) 10-2010-0080679

(51) Int. Cl. H04B 7/00

(52) U.S. Cl. 455/41.2

(57) ABSTRACT

Provided is an apparatus and method for sharing data in a portable terminal. The apparatus includes a first Bluetooth module, a second Bluetooth module, and a sharing managing unit. The first Bluetooth module is configured to set a first communication area to which the portable terminal belongs, and the second Bluetooth module is configured to set a second communication area adjacent to the first communication area. The sharing managing unit is configured to control the first Bluetooth module and the second Bluetooth module to share data including Bluetooth Ids of other terminals of the first communication area and data of the second communication area for a subsequent display.

### CLAIM OF PRIORITY

This application claims the benefit of priority under 35 U.S.C. §119(a) from a Korean patent application filed in the Korean Intellectual Property Office on Aug. 20, 2010 and assigned Serial No. 10-2010-0080679, the entire disclosure of which is hereby incorporated by reference in its entirety.

### BACKGROUND OF THE INVENTION

1. Field of the Invention

The present invention relates to an apparatus and method for sharing data in a portable terminal. More particularly, the present invention relates to an apparatus and method for expanding a Bluetooth coverage area of a portable terminal to share data with another adjacent portable terminal (hereinafter referred to as an adjacent terminal).

2. Description of the Related Art

The use of portable terminals is rapidly increasing due to their portability. To this end, service providers (terminal manufacturers) are competitively developing mobile terminals with more functions in order to attract more users. They include phone book, game, scheduler, short message service, multimedia message service, broadcast message service, Internet service, e-mail, GPS, wake-up call, MP3 (MPEG Audio Layer-3), and digital camera.

Another popular function provides a portable terminal to detect the location of a user in an emergency situation, thus assisting in saving a life. This user positioning function allows a portable terminal to share location information with adjacent terminals, thereby making it possible to display its own location and the locations of other users on the display screen.

That is, the user positioning function has evolved from detecting the terminal location to display of adjacent registered users in a display screen.

The location of the user is detected by detecting a location corresponding to a cell by using the location registration information of the portable terminal, or by measuring the location of the portable terminal via a satellite signal though a GPS function. To this end, the portable terminal typically uses a specific server to share location information. That is, the portable terminal connects with the server to transmit its own location information and receive location information of an adjacent terminal from the server.

However, the above conventional method involves costs associated with the use and connection to the server.

What is, therefore, required is an apparatus and method for sharing location information in a portable terminal at a low cost.

### SUMMARY OF THE INVENTION

An exemplary aspect of the present invention is to provide an apparatus and method for expanding a data sharing area in a portable terminal.

Another exemplary aspect of the present invention is to provide an apparatus and method for expanding a Bluetooth coverage area in a portable terminal.

Another exemplary aspect of the present invention is to provide an apparatus and method for expanding a communication coverage area of a portable terminal by using a plurality of Bluetooth modules.

In accordance with an aspect of the present invention, an apparatus for sharing data in a portable terminal includes a first Bluetooth module for setting a first communication area to which the portable terminal belongs; a second Bluetooth module for setting a second communication area adjacent to the first communication area; and a sharing managing unit for controlling the first Bluetooth module and the second Bluetooth module to share data between the first and second communication areas.

In accordance with another aspect of the present invention, a method for sharing data in a portable terminal includes setting a first communication area by a first Bluetooth module in a portable terminal with a plurality of Bluetooth modules; setting a second communication area adjacent to the first communication area by a second Bluetooth module; and sharing data of the first communication area and data of the second communication area.

### BRIEF DESCRIPTION OF THE DRAWINGS

The above and other exemplary aspects, features and advantages of the present invention will become more apparent to a person of ordinary skill in the art from the following detailed description when taken in conjunction with the accompanying drawings in which:

FIG. 1 is a block diagram of a portable terminal for expanding a data sharing area according to the present invention;

FIG. 2 is a flow diagram illustrating a data sharing process of a portable terminal according to the present invention;

FIG. 3 is a flow diagram illustrating a process for maintaining a communication connection with an adjacent terminal in a portable terminal according to the present invention;

FIG. 4 is a flow diagram illustrating a process for sharing location information with adjacent terminals in a portable terminal according to an exemplary embodiment of the present invention; and

FIG. 5 is a diagram illustrating a data sharing process of a mobile communication system according to an exemplary embodiment of the present invention.

### DETAILED DESCRIPTION

Preferred embodiments of the present invention will be described herein below with reference to the accompanying drawings. For the purposes of clarity and simplicity, detailed descriptions of well-known functions or configurations will be omitted as they would unnecessarily obscure the subject matters of the present invention.

The present invention provides an apparatus and method for expanding a data sharing area by using a portable terminal having a plurality of Bluetooth modules.

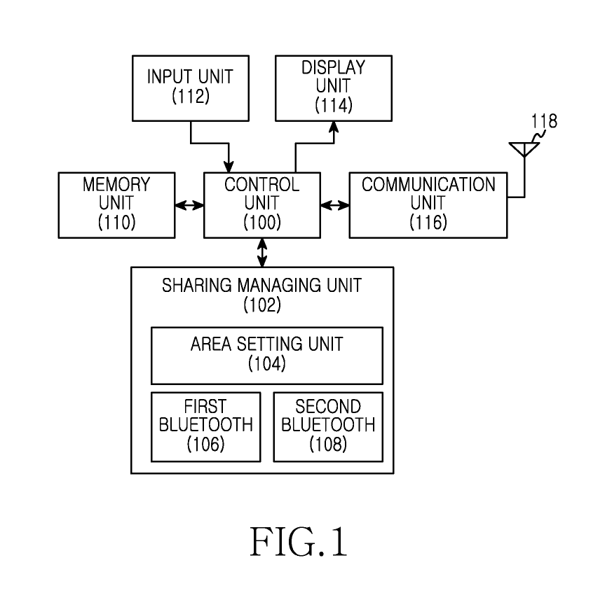

FIG. 1 is a block diagram of a portable terminal for expanding a data sharing area according to the present invention.

Referring now to FIG. 1, the portable terminal may include a control unit 100, a sharing managing unit 102, a memory unit 110, an input unit 112, a display unit 114, and a communication unit 116. The sharing managing unit 102 may include an area setting unit 104, a first Bluetooth module 106, and a second Bluetooth module 108. The portable communication terminal may include additional units that are not illustrated here for sake of clarity. Further, the functionality of two or more of the above units may be integrated into a single component.

In operation, the control unit 100 controls an overall operation of the portable terminal. For example, the control unit 100 processes and controls voice communication and data communication. In addition to the general functions, according to the present invention, the control unit 100 uses a plurality of Bluetooth modules (e.g., the first Bluetooth module 106 and second Bluetooth module 108) to expand a data sharing communication area. That is, the control unit 100 uses at least one Bluetooth module (e.g., the first Bluetooth module 106) that operates as a master to set a first communication area for an adjacent terminal operating as a slave and uses another Bluetooth module (e.g., the second Bluetooth module 108) that operates as a slave to set a second communication area for an adjacent terminal operating as a master. For illustrative purposes, only two Bluetooth modules are shown in FIG. 1, but it should be noted that a plurality of Bluetooth modules may be incorporated according to the teachings of the present invention.

Herein, the communication area for an adjacent area is set so that the portable terminal communicates with an adjacent terminal to receive information about the adjacent area.

The sharing managing unit 102 expands a data sharing communication area under the control of the control unit 100. That is, the sharing managing unit 102 uses at least one Bluetooth module to set a sharing area for its own area and uses another Bluetooth module to set a sharing area for an adjacent area.

The area setting unit 104 of the sharing managing unit 102 continuously maintains a preset sharing area. For example, when the portable terminal releases a connection with its own area or an adjacent area, the area setting unit 104 changes an operation mode of the Bluetooth module, searches adjacent terminals, and continuously maintains a communication connection with adjacent terminals.

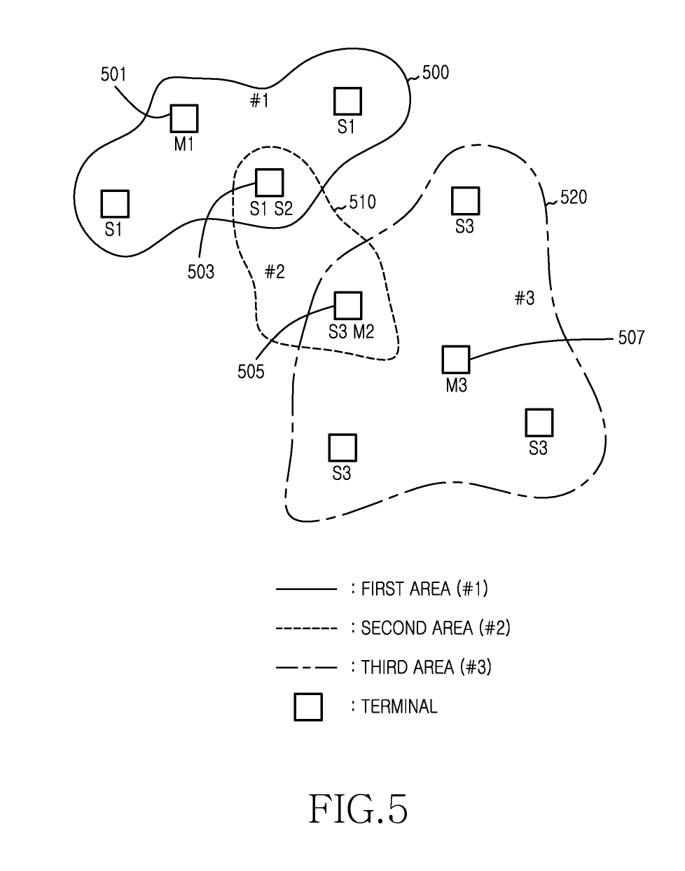

The first Bluetooth module 106 is used to set an area (i.e. first area) of the portable terminal, and the second Bluetooth module 108 is used to set an adjacent area (i.e., second area) of the portable terminal where the first area and the second area overaps. When the first Bluetooth module 106 operates as a master to communicate with slave terminals in the first area, the second Bluetooth module 108 in the overlapped area operates as a slave to connect with a master terminal of the second area. This process continues in more than one overlapped areas. Accordingly, the portable terminal can expand its own area and the adjacent area as the data sharing area which will be described later in details with reference to FIG. 5.

The memory unit 108 may include non-transitory machine readable medium(s), such as Read Only Memory (ROM), Random Access Memory (RAM), a flash ROM, or other similar storage devices. The ROM stores various reference data and microcodes of a program for the process and control of the control unit 100 and the sharing managing unit 102.

The RAM is a working memory of the control unit 100, which stores temporary data that are generated during the execution of various programs. The flash ROM stores various updatable data such as phone book, outgoing messages, and incoming messages.

The input unit 112 may include numeric keys of digits 0-9 and a plurality of function keys, such as a Menu key, a Cancel (Delete) key, a Confirmation key, a Talk key, an End key, an Internet connection key, Navigation keys (or Direction keys), and character input keys. The input unit 112 provides the control unit 100 with key input data corresponding to a key pressed by the user.

The display unit 114 may display numerals and characters, moving pictures, still pictures and status information generated during an operation of the portable terminal. The display unit 114 may be a color Liquid Crystal Display (LCD), an Active Mode Organic Light Emitting Diode (AMOLED) display, and/or other types of thin-film technology screen display apparatuses. If the display unit 114 has a touch input device and is applied to a touch input type portable terminal, it can be used as an input device.

The communication unit 116 transmits/receives Radio Frequency (RF) signals inputted/outputted through an antenna (118). For example, in a transmitting (TX) mode, the communication unit 116 channel-encodes, spreads and RF-processes TX data prior to transmission. In a receiving (RX) mode, the communication unit 116 converts a received RF signal into a baseband signal and despreads and channel-decodes the baseband signal to restore the original data. Also, the communication unit 116 may include a satellite signal receiving module for receiving location information of the portable terminal according to the present invention.

The communication unit 116 may also include a communication port for wired transfer, such as USB, and may also communicate in short-range protocols such as Bluetooth, etc. For example, time division, frequency division, are just a few examples of possible protocols. It is also to be appreciated by a person of ordinary skill in the art that the communication protocol is in no way limited to spread spectrum techniques.

The control unit 100 of the portable terminal may be configured to perform the function of the sharing managing unit 102. Although separate units are provided for respective functions of the control unit 100, the control unit 100 may be configured to perform all or some of the functions on behalf of such separate units.

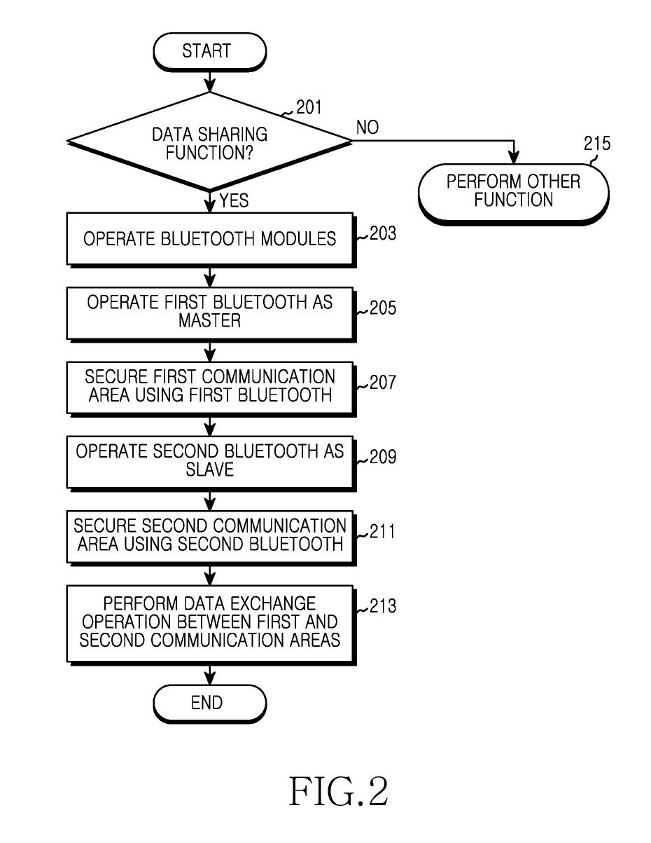

FIG. 2 is a flow diagram illustrating a data sharing process of a portable terminal according to the present invention.

Referring to FIG. 2, in step 201, the portable terminal determines whether to use a data sharing function. The data sharing function allows the portable terminal to exchange data with an adjacent terminal, and the data may include at least one of location information, business card information, and multimedia data.

If the data sharing function is not requested in step 201, the portable terminal performs other function (e.g., an idle mode) in step 215.

If the data sharing function is requested in step 201, the portable terminal operates a plurality of Bluetooth modules (first and second Bluetooth modules) in step 203. According to an exemplary embodiment, the portable terminal may include two Bluetooth modules for expansion of a communication area. The portable terminal may operate the first Bluetooth module as a master to perform a piconet connection with a slave-mode portable terminal located in a predetermined area, and may use the second Bluetooth module to perform a piconet connection on different areas to expand a communication area.

Thereafter, in step 205, the portable terminal operates the first Bluetooth module as a master. In step 207, the portable terminal uses the first Bluetooth module to secure a first communication area.

In step 209, the portable terminal operates the second Bluetooth module as a slave. In step 211, the portable terminal uses the second Bluetooth module to secure a second communication area. Note that the portable terminal here may operate the second Bluetooth module as a master. However, the present invention operates the second Bluetooth module as a slave in order to prevent the data sharing function from being interrupted due to a disconnection from an adjacent terminal when operating the first and second Bluetooth modules as masters.

Herein, the portable terminal may beforehand register Bluetooth IDs of adjacent terminals to simplify a connection process between terminals.

In step 213, the portable terminal performs a data exchange operation with the terminals located in the first and second communication areas.

In general, a portable terminal using one Bluetooth module can exchange data with a terminal located in a Bluetooth communication coverage area. However, the portable terminal according to the present invention uses a plurality of Bluetooth modules to increase the number of connectable terminals and expand a data exchange communication area.

Thereafter, the portable terminal ends the algorithm according to the present invention.

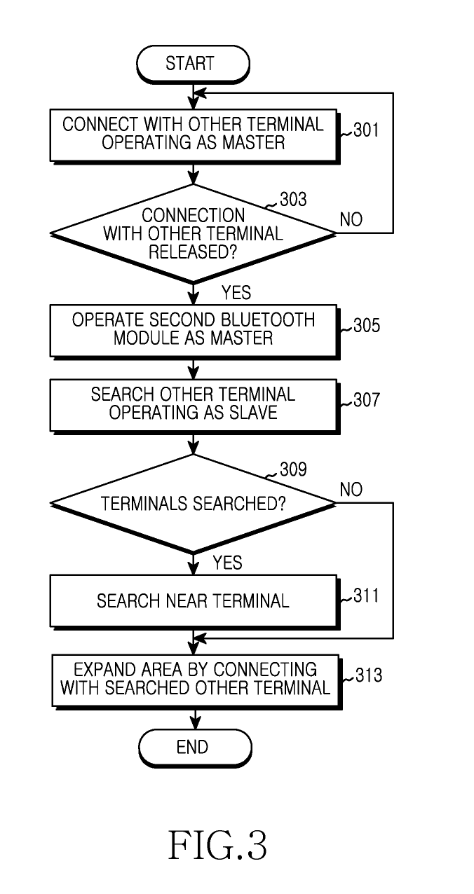

FIG. 3 is a flow diagram illustrating a process for maintaining a communication connection with an adjacent terminal by a portable terminal according to the present invention.

Referring now to FIG. 3, the portable terminal operates a first Bluetooth module as a master and a second Bluetooth module as a slave.

In step 301, the portable terminal in the overlapped area of a first area and a second area uses the second Bluetooth module to connect with an adjacent terminal operating as a master in the second area.

In step 303, the portable terminal determines whether the connection with the adjacent terminal is released. Herein, the connection with the adjacent terminal may be released due to a deviation of the portable terminal or the adjacent terminal from the communication coverage area, a power off of the portable terminal, or a Bluetooth module failure.

If the connection with the adjacent terminal is not released (in step 303), the portable terminal returns to step 301.

On the other hand, if the connection with the adjacent terminal is released (in step 303), the portable terminal proceeds to step 305. In step 305, the portable terminal having lost the communication link operates its second Bluetooth module as a master during this interruption period In step 307, the portable terminal having the second Bluetooth module operating as a master searches other adjacent terminal in the second area operating as a slave.

In step 309, the portable terminal determines whether a plurality of adjacent terminals operating as slaves has been searched.

If a plurality of adjacent terminals operating as slaves have been searched (in step 309), the portable terminal proceeds to step 311. In step 311, the portable terminal finds a nearest terminal. In step 313, the portable terminal performs a communication connection with the searched adjacent terminal. Herein, the portable terminal can connect with nearest terminal that operated as a slave and also to expand the communication area.

On the other hand, if a plurality of adjacent terminals operating as slaves have not been searched (in step 309), the portable terminal proceeds to step 313. In step 313, the portable terminal performs a communication connection with the searched adjacent terminal to expand a communication area.

Thereafter, the portable terminal ends the algorithm according to the present invention.

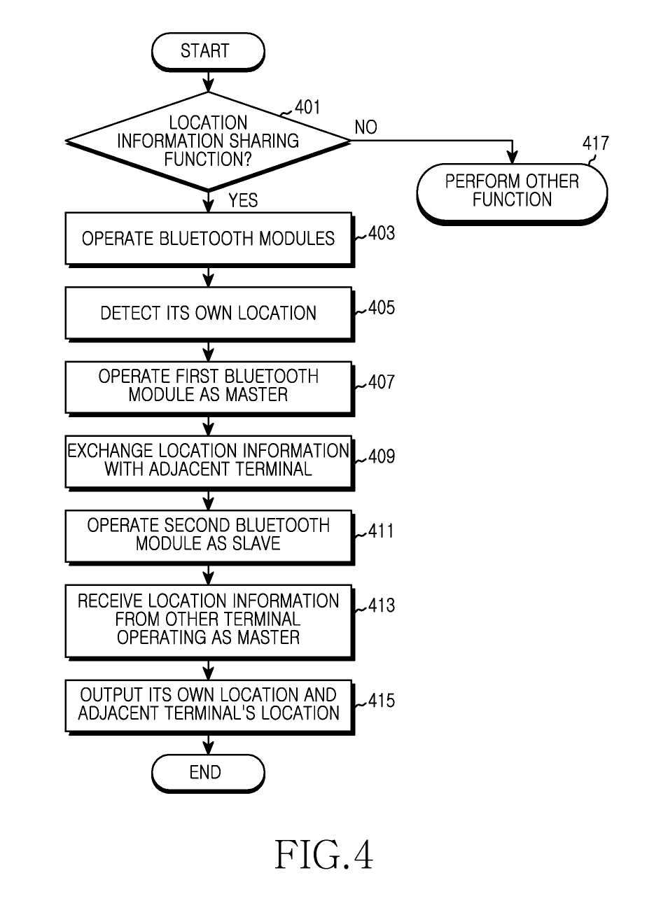

FIG. 4 is a flow diagram illustrating a process for sharing location information with adjacent terminals in a portable terminal according to an exemplary embodiment of the present invention.

Referring now to FIG. 4, in step 401, the portable terminal determines whether there is a request to perform a location information sharing operation.

If not (in step 401), the portable terminal performs other function (e.g., an idle mode) in step 417.

On the other hand, if there is a request to perform a location information sharing operation (in step 401), the portable terminal proceeds to step 403. In step 403, the portable terminal operates a plurality of Bluetooth modules. In step 405, the portable terminal detects its own location. Herein, the portable terminal may detect its own location by receiving location information through a satellite signal receiving module.

In step 407, the portable terminal operates the first Bluetooth module as a master to create a first network for sharing location information. In step 409, the portable terminal exchanges location information with terminals belonging to the first network.

In step 411, the portable terminal operates the second Bluetooth module as a slave to create a second network different from the first network created in step 407. In step 413, the portable terminal receives location information of the terminals included in the second network, from a terminal that is operated as a master in the second network. This may be described as a bridge function that a slave terminal belonging to the first network operates as the terminal belonging to the second network to connect the two networks. For example, if a terminal A is located in the first network and a terminal B is located in an overlap between the first and second networks, the terminal B and the terminal A included in the first network can receive location information of the correspondent terminal through the master terminal. Also, the terminal B can receive location information of the terminal located in the second network which can be relayed to the terminal B, so that the terminal A can detect location information of the terminals belonging to the second network, through the terminal B.

In step 415, the portable terminal outputs its own location and the locations of adjacent terminals. That is, the portable terminal outputs location information of the terminals belonging to the first network and location information of the terminals belonging to the second network.

Thereafter, the portable terminal ends the algorithm according to the present invention.

FIG. 5 is a diagram illustrating a data sharing process of a mobile communication system according to an exemplary embodiment of the present invention.

Referring to FIG. 5, the mobile communication system may include three Bluetooth communication areas 500, 510 and 520. Terminals with a plurality of Bluetooth modules are located in each of the Bluetooth communication areas 500, 510 and 520. A sign marked on each terminal represents an operation state of the terminal. For example, M# represents an operation state of the first Bluetooth module and means that the first Bluetooth module operates as a master in the #^{th} area. M#S! can represent an operation state of the first Bluetooth module and an operation state of the second Bluetooth module and indicates that the first Bluetooth module operates as a master in the #^{th} area and the second Bluetooth module operates as a slave in the !^{th} area. For example, M1S2 means the portable that is the first Bluetooth module operates as a master in the 1^{st} area and the second Bluetooth module operates as a slave in the 2^{nd} area. Accordingly, in FIG. 5, S1M2 represents the portable terminal whose first Bluetooth module operates as a slave in the 1^{st} area and the second Bluetooth module operates as a master in the 2^{nd} area.

As illustrated in FIG. 5, the terminal 503 overlapping with another area, among the terminals located in the first area 500, can connect with the first area 500 through the first Bluetooth module, and can connect with another overlapping area (the second area 510) through the second Bluetooth module, thus expanding the communication coverage area of the portable terminal.

The terminal 503 located at the position overlapping with the areas (the position corresponding to the overlap between the first area and the second area) receives location information from a master 505 of the second area 510 and provides a master 501 of the first area 500 with location information of the terminals located in the second area 510. When the master 505 of the second area 510 overlaps with the third area 520, the master 505 receives location information about the third area 520 from a master 507 of the third area 520 and provides the location information about the second area 500 and the third area 520 to the slave terminal 503 located at the overlap between the first area 500 and the second area 510. Consequently, all the terminals located in the first, second and third areas can detect the location information of the respective terminals.

The conventional portable terminal can detect location information of only the terminals located in its own area among the first, second and third areas 500, 510 and 520, whereas the portable terminal according to an exemplary embodiment of the present invention can detect location information of all the terminals located in the first, second and third areas 500, 510 and 520. Thus, the terminals knowing presence and location of other adjacent terminals in other areas can display the location of other terminals without going to a specific server as in the conventional art.

Further, if the connection with at least one of the connected portable terminals is released, the disconnected terminal knowing the presence of other adjacent terminal without the aid of a server can change a communication mode of the Bluetooth module and searches an adjacent terminal to maintain a communication connection therebetween, as described with reference to FIG. 3.

As described above, the present invention is to expand a data sharing area in a portable terminal with a plurality of Bluetooth modules. The portable terminal uses at least one Bluetooth module to set a sharing area for its own area and uses another Bluetooth module to set a sharing area for an adjacent area, thereby making it possible to set a wider sharing area than the conventional portable terminal.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

what is claimed is:

1. An apparatus for sharing data in a portable terminal, comprising:
a first Bluetooth module for setting a first communication area for the terminal;
a second Bluetooth module for setting a second communication area adjacent to the first communication area; and
a sharing managing unit for controlling the first Bluetooth module and the second Bluetooth module to share data amongst terminals between the first communication area and the second communication area, wherein the second Bluetooth module establishes a connection with an adjacent terminal operating as a master in the second communication area.

2. The apparatus of claim 1, wherein the sharing managing unit operates the first Bluetooth module as a master to connect with an adjacent terminal.

3. The apparatus of claim 1, wherein the sharing managing unit operates the second Bluetooth module as a slave to connect with an adjacent terminal.

4. The apparatus of claim 3, wherein, when a communication link fails, the sharing managing unit operates the second Bluetooth module of the terminal as a master to search for the adjacent terminal.

5. The apparatus of claim 3, wherein the sharing managing unit connects to a nearest terminal.

6. The apparatus of claim 1, wherein the data includes at least one of location information, business card information, and multimedia data.

7. The apparatus of claim 1, wherein the sharing managing unit share the data between the first communication area and the second communication area without establishing a connection to a server.

8. The apparatus of claim 1, wherein the second Bluetooth module in communication with the adjacent terminal operating as the master in the second area obtains other terminal information in the second area for sharing

9. The apparatus of claim 1, wherein the sharing managing unit stores Bluetooth IDs of other terminals for a subsequent display.

10. The apparatus of claim 1, wherein the adjacent terminal having a third communication area adjacent to the second communication area shares data with the terminal so that location data information of all terminals located in the first, second and third communication areas are shared.

11. A method for sharing data by a terminal, comprising:
establishing a first communication area by a first Bluetooth module of the terminal;
establishing a second communication area adjacent to the first communication area by a second Bluetooth module of the terminal;
establishing a connection with an adjacent terminal operating as a mater in the second communication area by the second Bluetooth module; and
sharing data amongst terminals between the first communication area and data of the second communication area through the established connection.

12. The method of claim 11, wherein sharing of the data between the first communication area and the second communication area by the portable terminal is achieved without establishing a connection to a server.

13. The method of claim 11, wherein, when a communication link fails, the second Bluetooth module of the terminal as a master to search for the adjacent terminal.

14. The method of claim 11, wherein the second Bluetooth module operating as the master connects to a nearest terminal.

15. The method of claim 14, wherein the data includes at least one of location information, business card information, and multimedia data.

16. The method of claim 11, wherein the second Bluetooth module in communication with the adjacent terminal operating as the master in the second area obtains other terminal information in the second area for sharing.

17. The method of claim 16, wherein Bluetooth IDs of other terminals are stored for a subsequent display.

18. The method of claim 11, further comprising establishing a third communication area adjacent to the second communication area by a first Bluetooth module of the adjacent terminal operating as the mater; and sharing location data information by all terminals located in the first, second and third communication areas.
